(19) United States
(12) Patent Application Publication
(10) Pub. No.: US 2004/0140996 A1
(43) Pub. Date: Jul. 22, 2004

(54) Contents display device and method

(76) Inventors: Tomoki Sekiguci, Sagamihara (JP); Akihiro Itoh, Yokohama (JP); Naoki Utsunomiya, Machida (JP)

Correspondence Address: MATTINGLY, STANGER & MALUR, P.C., SUITE 370, 1800 DIAGONAL ROAD, ALEXANDRIA, VA, 22314, US

(21) Appl. No.: 10/393,248

(22) Filed: Mar. 21, 2003

(30) Foreign Application Priority Data
Jan. 21, 2003 (JP) 2003-011744

(51) Int. Cl. G09G 5/00

(52) U.S. Cl. 345/716

(57) ABSTRACT

Where various contents are distributed to mobile devices from a network, the mobile user must frequently operate the device to cancel and select contents until a desired content is displayed. According to the present invention, a mobile device to receive contents distributed from the network is provided with contents display means to display plural contents sequentially part by part in an interleaved manner on the contents display unit. After a part of a content is displayed for a certain period of time, a part of another content is automatically selected and displayed. In addition, the contents display means includes means to continuously display the current content if instructed by the user.

### BACKGROUND OF THE INVENTION

The present invention relates to a method for displaying contents, each of which is composed of plural still images or a motion picture delivered via a network accessible in a certain region.

With the development of radio technology, we have become able to freely acquire information (hereafter content(s)) from a network both indoors and outdoors by connecting to the network via a mobile telephone or wireless LAN. Use of such wireless communication for providing local information to terminal users is under consideration. For example, a system for this kind of service is disclosed in Japanese Patent Laid-open No. 2002-9691. In this system, information originators are provided with contents creating terminals, a central server collects contents and a distribution device located in each area transmits contents to mobile devices in the area. Also a method for displaying a plurality of contents is disclosed in Japanese Patent Laid-open No. 2002-152672. In this method, contents are reproduced on the reception device side in the order instructed by a central server.

A motion picture or a group of still images, created by an originator, is treated as a single content. To display such a content, a certain period of time is spent. For the user to display a content while another content is displayed, the user must operate to terminate the currently displayed content and then display the new content. In this case, it is difficult to show many contents to the user if the user is passively viewing contents. To get general idea of each piece of local information available there, the user must perform troublesome operation.

In addition, it is conventionally impossible to clearly know what contents gather interest from the users. That is, it is not possible to judge whether a user showed interest in a content unless some operation is done by the user to inform of his interest after the content is displayed.

### SUMMARY OF THE INVENTION

According to one aspect of the present invention, there is provided a terminal for receiving and displaying distributed plural contents each consisting of plural still images and/or a motion picture. The terminal is provided with means for displaying the plural contents sequentially part by part in such a manner that part of a content A is displayed for a certain period of time before part of another content is automatically displayed. In addition, part of the content A to be displayed in the next turn is the one which just follows the part displayed in the last turn of the content A. This allows the user to view many contents without performing special operation.

The contents display means has a procedure to continuously display the current content if instructed by the user.

The mobile device signals to the distribution server that the content is selected, allowing the creator of the content to easily know whether the content gathers attention.

According to the present invention, plural contents distributed from a distribution server can be viewed sequentially by the user in an automatically and periodically interleaved manner. Accordingly, the user is not forced to see the same content for a long time. In addition, the user does not have to perform operation to skip such contents to other ones and therefore can easily get a general idea of each of the various contents distributed from the distribution server. For the contents distribution side, it is possible to increase the number of contents viewed by the user since plural contents are displayed part by part in an interleaved manner.

### BRIEF DESCRIPTION OF THE DRAWINGS

Other objects and advantages of the invention will become apparent from the following description of embodiments with reference to the accompanying drawings in which:

FIG. 1 is a block diagram showing a whole network system according to a first embodiment of the present invention;

FIG. 2 shows the configuration of a contents distribution server;

FIG. 3 shows the configuration of a mobile device;

FIG. 4 is a flowchart showing a procedure of processing for registering/displaying contents;

FIG. 5 is a flowchart showing a procedure of processing for updating the contents display;

FIG. 6 is a schematic diagram showing a GUI of the mobile device;

FIG. 7 is a diagram explaining a procedure of processing for selecting a contents display mode;

FIG. 8 is a flowchart showing a procedure of processing for displaying a content continuously;

FIG. 9 is a block diagram showing a whole network system according to a second embodiment of the present invention; and

FIG. 10 is a flowchart showing a procedure of processing for accounting.

### DETAILED DESCRIPTION OF THE PREFERRED EMBODIMENTS

With reference to the drawings, the following will describe preferred embodiments of the present invention. In these embodiments, contents creators create contents each of which consists of plural still images and a user receives a plurality of contents from a contents distribution server and views these received contents part by part in an interleaved manner.

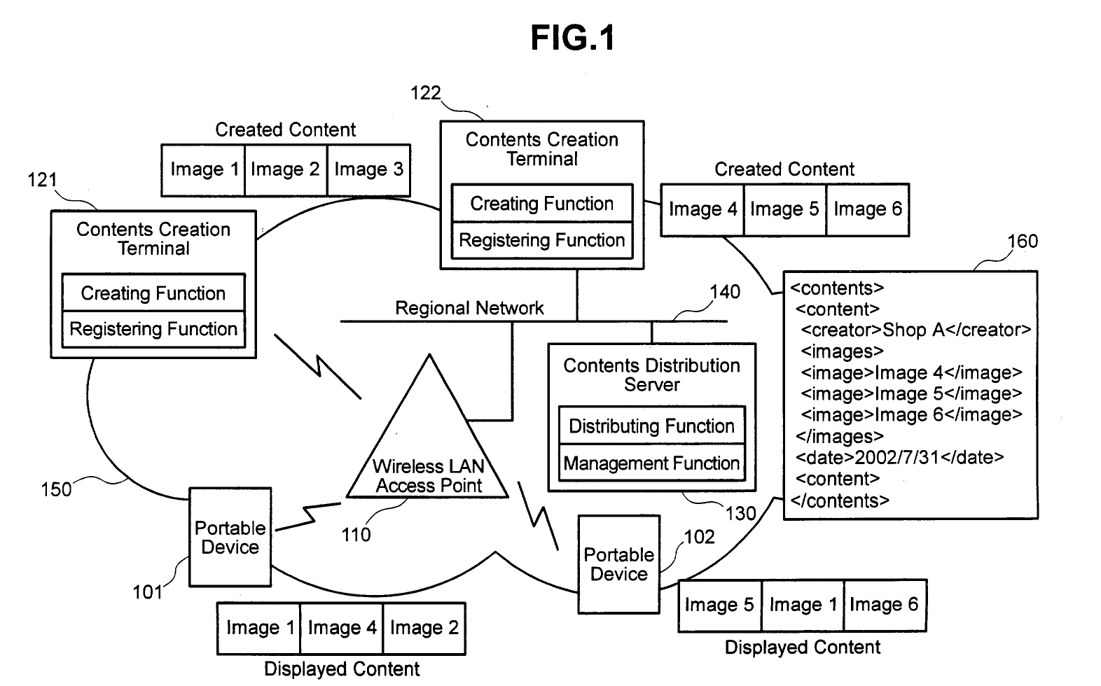

FIG. 1 shows the general configuration of a system according to an embodiment of the present invention. Contents creation terminals 121 and 122, a contents distribution server 130, a wireless LAN access point 110 and mobile devices 101 and 102 are connected to a regional network 140.

The contents creation terminals 121 and 122 can be used to prepare contents which are to be distributed via the network. Each content consists of a motion picture or plural still images or a combination of a motion picture and still images. The contents creation terminals 121 and 122 are also provided with a capability of registering the created contents to the contents distribution server 130. The contents creation terminal 121 is connected to the regional network 140 via a wireless LAN while the contents creation terminal 122 is directly connected to the regional network 140 by wire connection. A contents creator prepares contents by using a contents creation terminal 121 or 122.

In FIG. 1, the contents creation terminals 121 and 122 have respectively created a content consisting of still images 1 through 3 and a content consisting of still images 4 through 6 and registered the contents to the contents distribution server 130. An XML document 160 is a data form transmitted to the contents distribution server 130 in order to register the content created by the contents creation terminal 122. The information contained in the XML document 160 indicates the creator of the content, the list of still images constituting the content, the order in which the still images are to be displayed and the date when the content was created. The respective still images are numbered in the display order.

The contents distribution server 130 is provided with a capability of managing the contents registered from the contents creation terminals and a capability of distributing contents to the regional network 140. Although there is a single contents distribution server 130 in this figure, it is also possible to connect a plurality of contents distribution servers to the regional network.

The access point 110 allows data communication between the wired network and the mobile devices and terminals provided with wireless LAN facilities. To carry out wireless communication, the access point 110 is provided with a capability of assigning a network address to each terminal which connects to the regional network 140 via the access point 110. This network address assignment can be realized by, for example, a DHCP server mounted thereon. In addition, the access point 110 is given a unique name for discrimination from the other access points.

In the access range 150 of the wireless LAN access point 110, there are mobile devices 101 and 102 connectable to the network via a wireless LAN. The devices 101 and 102 are provided with contents display means for receiving and displaying contents distributed from the contents distribution server 130.

The contents display means mounted on each of the mobile devices 101 and 102 demands contents by broadcasting the assigned network address to the regional network 140. The contents distribution server 130 receives this demand and transmits the registered contents to the address. Upon receiving the contents, the mobile device generates a new sequence of still images in such a manner that plural contents registered by the respective originators are interleaved. The mobile device displays the contents according to this sequence. In FIG. 1, the device 101 displays images 1, 4 and 2 in this order and likewise the device 102 displays images 5, 1 and 6. Each device obtains the contents of two contents creators and displays them part by part sequentially and alternately.

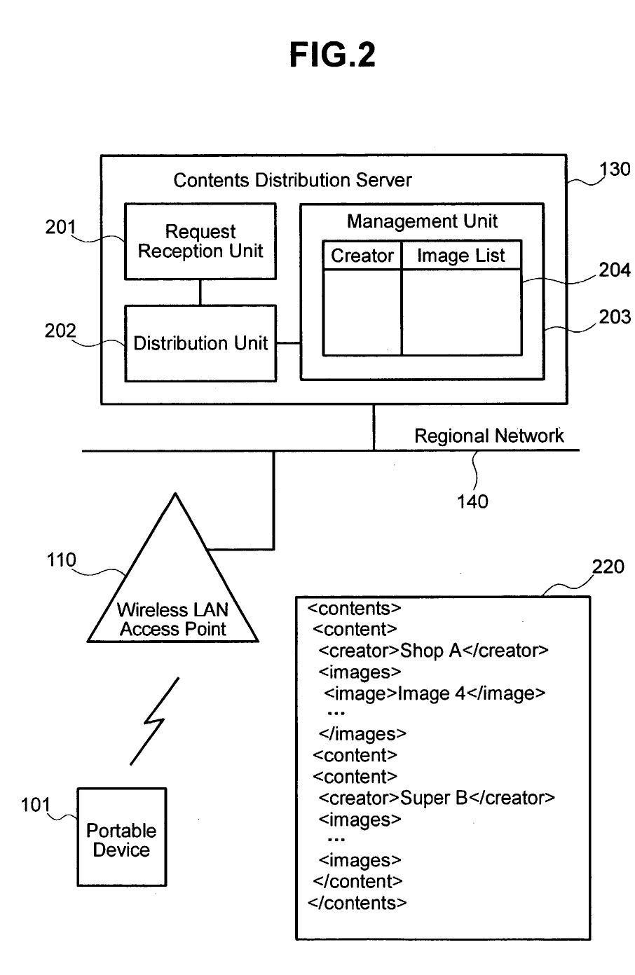

With reference to FIG. 2, the following will describe the contents distribution server 130 in detail. FIG. 2 shows the configuration of the software which makes the contents distribution server 130 carry out contents distribution. The software is stored on a hard disk. Although not shown in this figure, the contents distribution server 130 is provided with a CPU, memory, communication controller and other hardware resources required to execute the software. The CPU implements the distributing function in conjunction with the software by reading out the software modules sequentially from the hard disk via the memory and executing them.

The software comprises a request reception module 201, a distribution module 202 and a management module 203. The request reception module 201 is waiting for contents requests from clients. Upon receiving a request from a client, the request reception module 201 instructs the distribution module 202 to distribute contents to the client. For example, if the mobile device 101 connects to the regional network 140, it broadcasts a contents distribution request to the regional network 140. Upon receiving this broadcast, the server 130 delivers contents.

The management module 203 receives contents from the contents creation terminals 121 and 122 and stores them into the storage area of the server 130. When requested from the distribution module 202, the management module 203 passes contents to the distribution module 202. The management module 203 retains a management table 204 where the creator of each content is recorded with a group of still images constituting the content.

The distribution module 202 distributes contents to the client as instructed by the request reception module 201. The contents to be distributed are obtained from the management module 203. For simplification here, it is assumed that all contents stored in the management table 204 are obtained. Accordingly, they are transmitted in the form of a XML document 220. This XML document 220 is made of a plurality of documents 160, each of which has been registered by the corresponding creator. No particular rule is applied here to the order of these documents 160 included in the document 220.

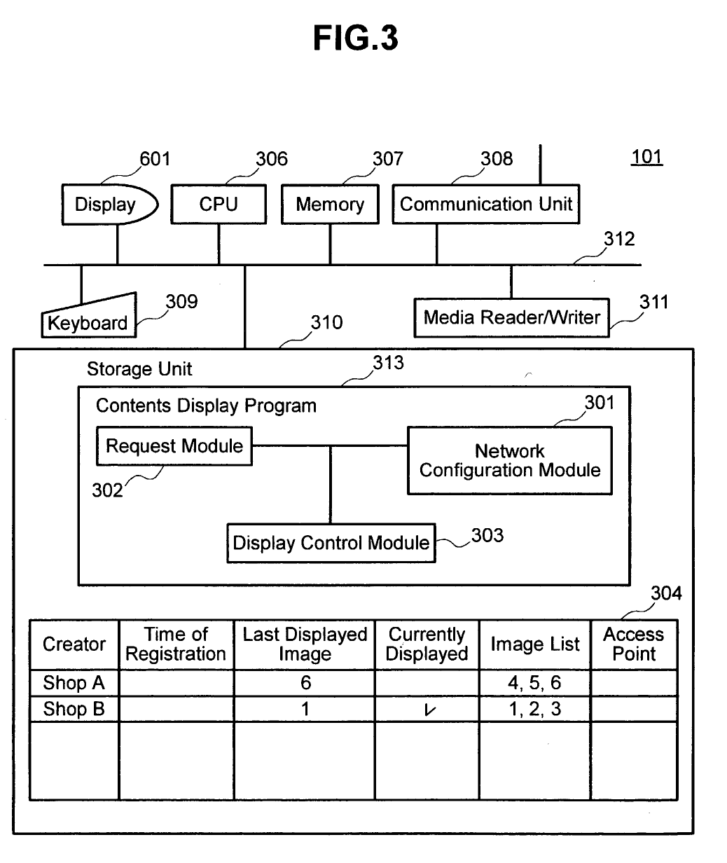

FIG. 3 shows the configuration of the mobile device 101. A storage unit 310 consists of a hard disk or the like and retains a contents display program 313 and a display control table 304 for the management of contents display information. The table 304 indicates the creator of each obtained content, the date when the content was created, the number of the last displayed still image, the state of a flag showing whether the content is currently being displayed, a list of still images constituting the content and the access point connected when the content was obtained. The display control table 304 is under the management of the contents display means in the mobile device 101. In FIG. 3, this table indicates that the mobile device 101 is now displaying image 1 of the store A content, displays the last image 6 of the store B contents, and will select image 4 of the store B content as the next image to be displayed.

A network configuration module 301 controls connection to the wireless LAN access point 110. If the access point is detected, the network configuration module 301 obtains a network address for communication via the access point 110 and notifies a request module 302 that the access point is connected.

The network configuration module 301 detects not only connection to the access point 110 but also disconnection from the access point 110. If disconnection from the access point 110 is detected, the network configuration module 301 removes from the management table 304 the contents obtained while the access point was connected.

If the request module 302 is notified that the mobile device 101 is connected to the regional network 140, it broadcasts a contents distribution request to the network 140. This request carries the network address assigned to the mobile device.

The request module 302 receives contents sent in the data form of the XML document 220 from the contents distribution server 130. Then the request module 302 registers the received contents to the management table 304.

The request module 302 may be modified in such a manner that the latest contents are periodically obtained after connected to the regional network 140. In this case, the oldest content may be replaced by the newest one according to the dates when the respective contents were registered. Further, the request module 302 may be modified in such a manner that whenever a new contents distribution server is connected to the regional network 140, contents are obtained from the server.

The display control module 303 displays the contents registered in the management table 304. In this embodiment, each of the contents consists of plural still images and the mobile device 102 receives the contents in the form of the XML document 220. The display control module obtains still images from the XML document 220 and displays them in the screen of the mobile device 101. The display control module 303 displays the still images in such a manner that one still image is displayed for a certain period of time and then a still image of another creator's content is displayed likewise.

The mobile device 101 is provided with a CPU 306, a work memory 207 for the CPU, a display 601 which visually outputs the processing result of the CPU, a keyboard 309 for entering the device user's instructions, a media reader/writer 311 to allow the contents display program to be read in from a storage medium such as a CD-ROM, a communication unit 308 controlling communication with other devices and network access points, and an internal bus 312 for allowing communication among these components. The CPU 306 implements the functions of the contents display program 313 by reading out the program module by module from the storage unit 310 via the memory 307 and executing them. Note that the mobile device 102 has the same configuration as that of the mobile device 101.

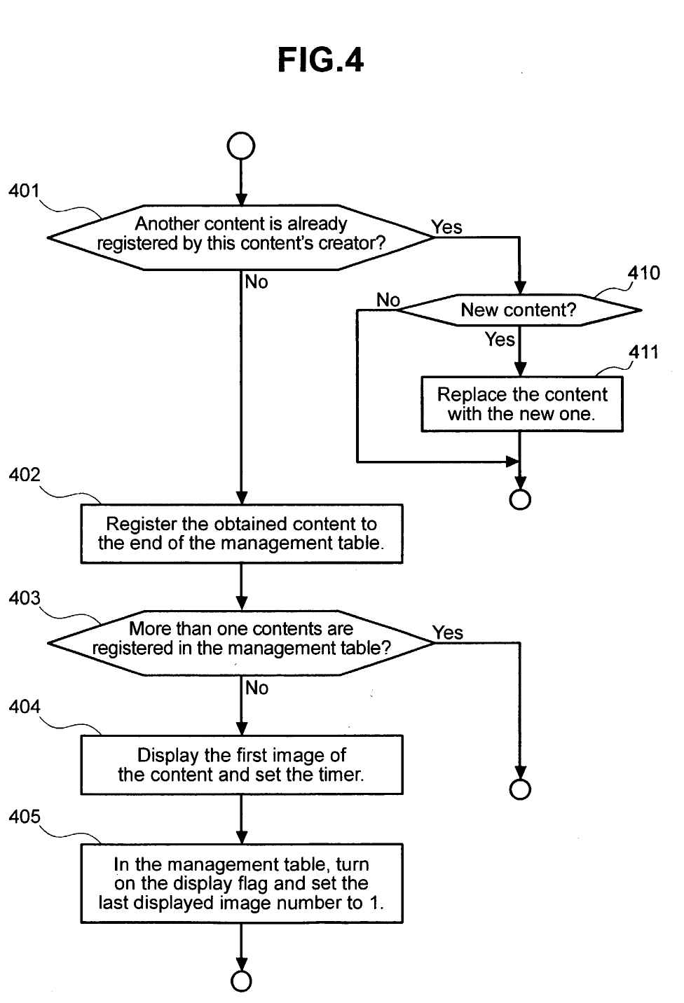

The following will describe the procedure of displaying contents. FIG. 4 is a flowchart showing flows of processing done by the request module 302 after contents are obtained. The request module 302 executes step 401 and subsequent steps for each of the obtained contents, that is, for each content stored in the received XML document transmitted in the format 220.

First, it is examined whether another content of the creator of the content being processed has been registered to the management table 304 (step 401). If registered, the date when the currently processed content was created is compared with that of the content registered in the management table 304 (step 410). If the currently processed content is newer, the content in the management table 304 is replaced by the newer content (step 411).

If another content of the creator of the currently processed content has not been registered, the content is registered to the management table 304 (step 402) and it is examined whether any other content exists in the management table 304 (step 304). If any other content exists, since it can be regards as that the processing displaying another contents has already been started, the processing is terminated. If any other content does not exist, the contents display processing is started. The first still image of the content is displayed with an image switching timer set to a predetermined time value (step 404). Then, the display flag and last displayed image number of the content are respectively turned on and set to 1 in the management table 304 (step 405).

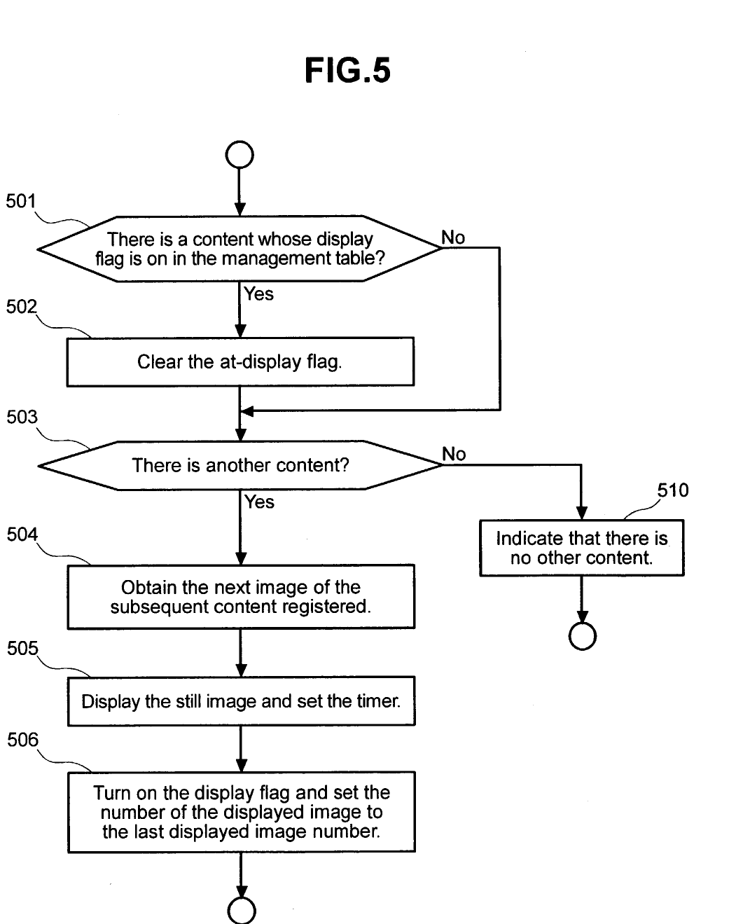

The following describes the flows of processing to be taken after the image switching timer reaches the time set at step 404. If the timer reaches the set time, image switching processing is started. FIG. 5 is a flowchart of the image switching processing.

First, the management table 304 is searched for a content whose display flag is on (step 501). If found, the display flag of the content is cleared (step 502).

Then, it is examined whether the management table 304 has a registered content (step 503). If there is no registered content since all contents are removed after disconnected from the network, the processing is terminated after it indicates that there is no content (step 510).

The next content to be selected is determined from the management table 304 and the next still image to be displayed is obtained from the content (step 504).

It is assumed in this embodiment that contents are displayed in the same order as they were registered. After the last registered content is displayed, the first registered content is selected from the management table 304. Similarly, images are displayed in the ascending order of image numbers. Displaying an image results in setting its image number to the last displayed image number of the content in the management table 304. When the same content is to be displayed, the image number just following the last displayed image number is selected as the image number of the next image to be displayed. If the last displayed image number is the final one, the first image number is selected as the image number of the next image to be displayed.

An obtained still image is displayed with the image switching timer set to the predetermined time (step 505). The display flag and the last displayed image number of the selected content are respectively turned on and updated in the management table (step 506).

The procedure mentioned above allows the mobile device 101 to automatically display plural still images of plural contents to the user in an interleaved manner. Accordingly, the user is not forced to see the same content for a long time. In addition, the user need not perform operation to skip such contents to other ones.

The following describes how the user operates when being interested in a content. Assume that the user is viewing plural contents of plural creators in an interleaved manner on the mobile device 101. If the user of the mobile device 101 is interested in a content, the user clicks the screen or hits a button provided on the mobile device 101 to continuously display the content. This continuous display processing is described below.

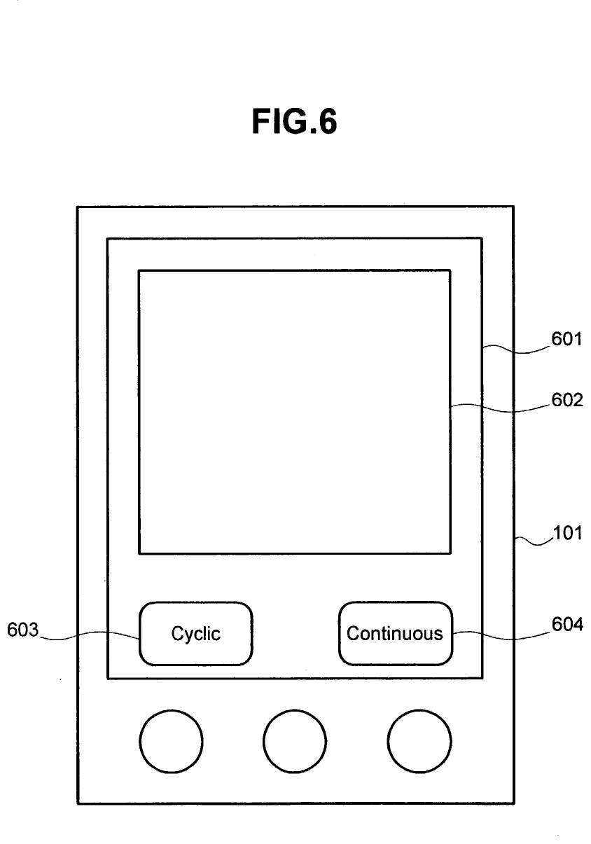

FIG. 6 shows a GUI of the contents display means executed on the mobile device 101. The GUI appears on the display 601. The contents display means displays the still images of contents on the display area 602. The GUI comprises buttons 603 and 604 which allow the user to select a contents display mode.

Usually, the contents display procedure according to the present invention displays a plurality of contents in the area 602 in an interleaved manner as mentioned above. If the GUI button 604 is hit by the user, the contents display procedure continuously displays the current content including the still image being displayed. If the button 603 is hit by the user while a content is continuously displayed, the contents display procedure switches the display mode to the interleaved display mode to display a plurality of contents.

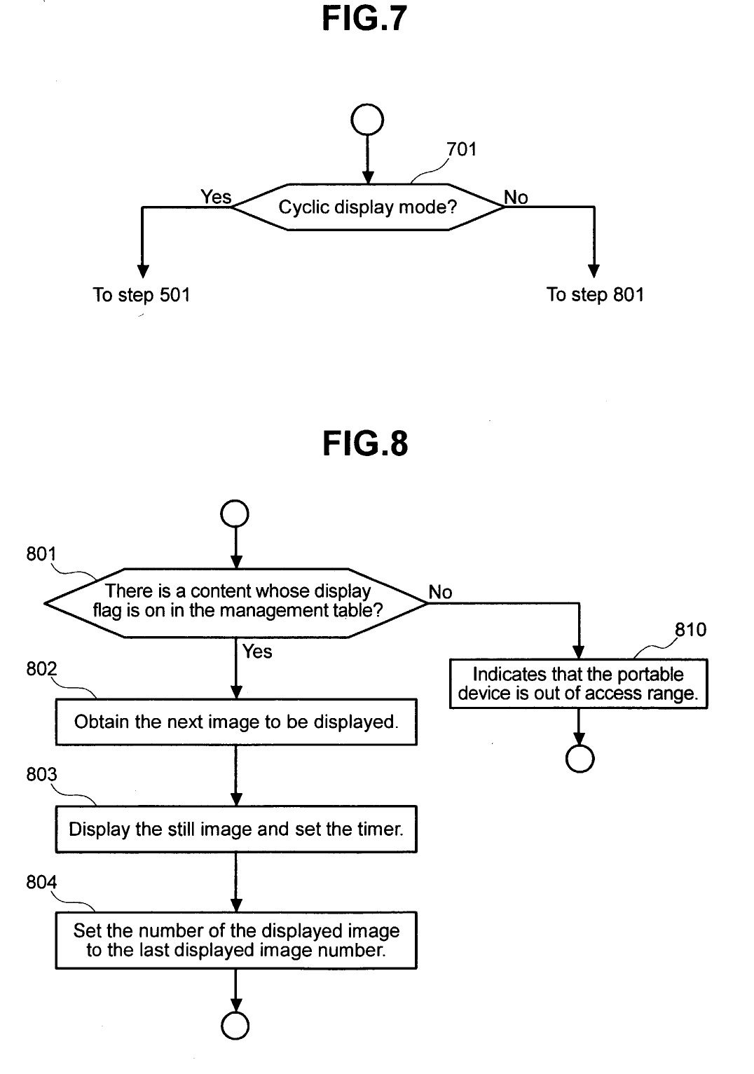

FIG. 7 is a flowchart of the image switching timer processing. The contents display procedure internally has a state variable indicating the current contents display mode. By referring to this variable, the image switching timer processing switches the still image display processing (step 701). The contents display means updates this display mode indication state variable if the button 603 or 604 is pressed down.

FIG. 8 is a flowchart showing flows of the image switching timer processing when a content is displayed continuously. First, the management table 304 is searched for a content whose display flag is on (step 801). If not found, the processing is terminated with a message displayed to indicate that the user is out of the access range of the wireless LAN access point 11 (step 810). If found, the next image to be displayed is obtained from the currently displayed content (step 802), then, the processing displays the obtained still image, sets the predetermined time to the image switching timer (step 803) and updates the last displayed image number of the content in the management table 304 (step 804).

The aforementioned procedure allows the user of the mobile device 101 to select a content and display the content continuously. The mobile device 101 may also be configured in such a manner that if the continuous viewing button 604 is held down, the mobile device 101 not only starts the flows of FIG. 8 but also signals the contents distribution server 130 that continuous display of a content is selected. In this case, the contents creator/distributor side can simply know what contents gather attention or interest. In particular, this is effective in fetching interest from users who are passively viewing contents.

Although in the description so far of the first embodiment, it is assumed that every content is composed of a plurality of still images, this does not mean that the present invention limits the contents to this type. The present invention is also applicable to contents containing motion pictures. A motion picture contained in a content can be treated similarly if the motion picture is started, interrupted and resumed by the image switching timer processing. In this case, the last displayed position is recorded in place of the last displayed image number in the management table 304. The display procedure plays the motion picture for a certain period of time before switching to an image of another content.

For example, at step 504 of FIG. 5 where the next image to be displayed is obtained, the motion picture to be resumed or another motion picture to be played may be obtained together with the play resume position so as to play the motion picture at step 505. After a motion picture is played, its play resume position is recorded in place of the last displayed image number in the management table 304.

In addition, although it is assumed that in the first embodiment, all contents are created by contents creators and distributed by the contents distribution server 130, contents distribution is not limited to this style. For example, devices and terminals connected the regional network 140 may directly distribute contents. In a second embodiment of the present invention, contents are distributed by contents creation terminals.

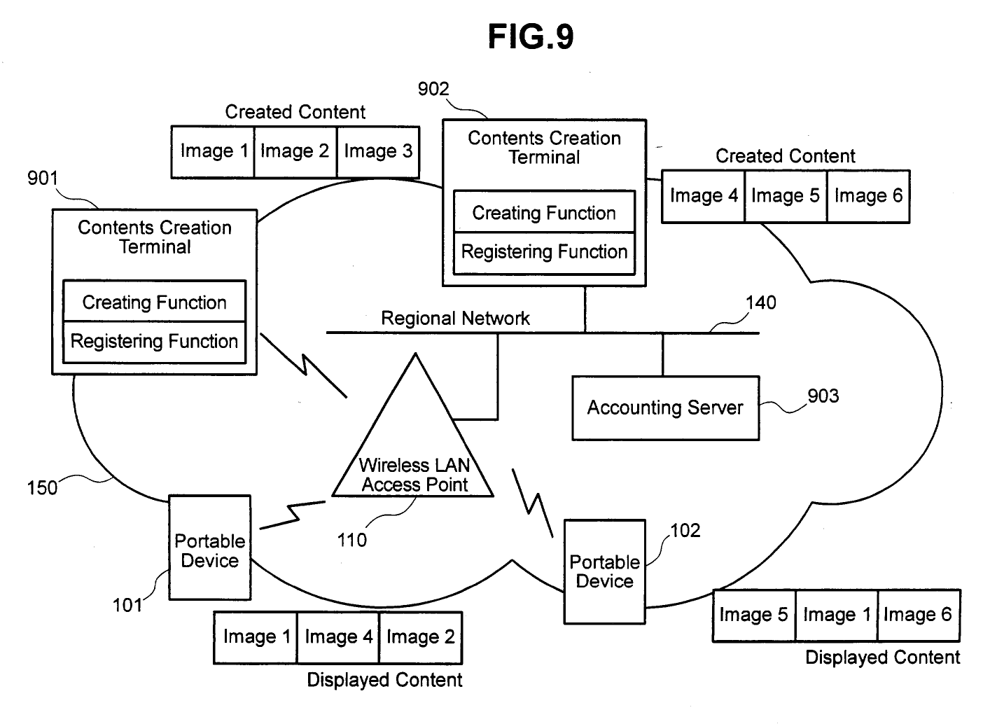

FIG. 9 shows the configuration of a network in which contents creation terminals can distribute contents. Contents creation terminals 901 and 902 have a function to distribute contents instead of the function to register them. This distributing function covers the function of the request reception module 201 and that of the distribution module 202 both in the contents distribution server 130. That is, the terminal 901 receives a contents distribution request and distributes contents created by its creating function.

This situation characterized by a plurality of terminals capable of distributing contents corresponds to a variation of the first embodiment provided with two contents distribution servers. Accordingly the same distribution procedure and display procedure described in the first embodiment can be implemented in this embodiment.

Since each contents creation terminal is provided with the contents distributing function, it is possible to easily change a content and its distribution time without the complicated management of the contents distribution server 130. The contents creator can change contents more freely, enabling timely issuance of contents. In addition, the contents creator can freely set the content distribution time.

Then, a third embodiment of the present invention is described. In this embodiment, when displaying a content continuously, the user is charged.

In FIG. 9, an accounting server 903 is connected to the regional network 140. The accounting server 903 receives accounting information from a mobile device and charges the user of the mobile device.

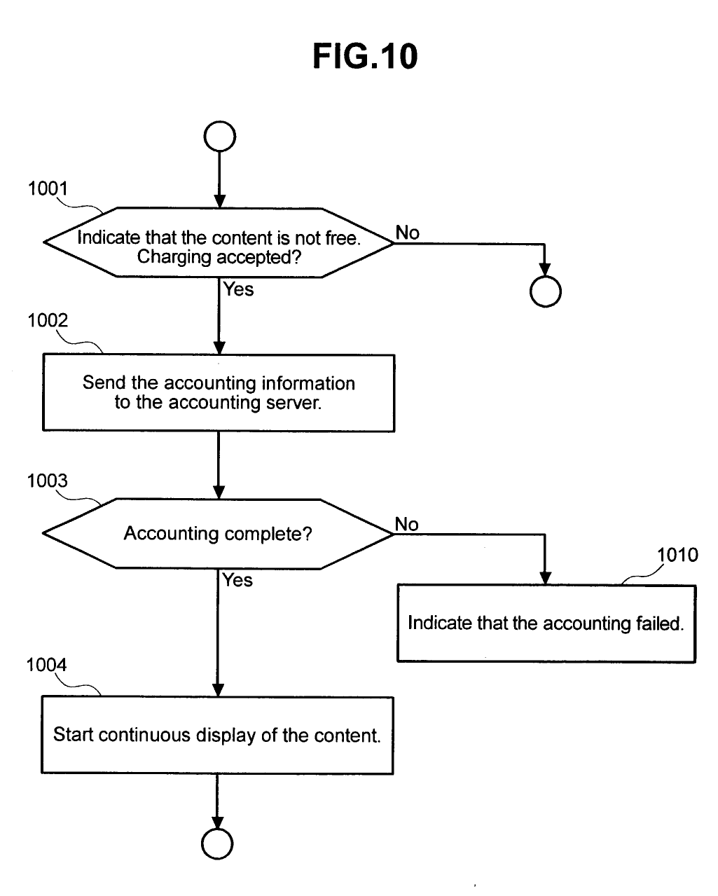

FIG. 10 is a flowchart showing flows of processing done by the display control module 303 to charge the user when a content is displayed continuously. First, displaying a content continuously is selected, the user is notified that the user is to be charged and asked if the user accepts the charging (step 1001). If accepted, accounting information is transmitted to the accounting server (step 1002). The accounting information includes the creator of the content, the user ID and other items required to charge the user. After transmitted, it is checked if the accounting has completed normally (step 1003). If the accounting is failed, the processing is terminated with a message indicating the fail (step 1010). If completed normally, the content begins to be displayed continuously (step 1004). This makes it possible to display a content intermittently or continuously depending on whether the user pays a fee.

In the first through third embodiments mentioned so far, plural contents distributed by a distribution sever are periodically displayed to the user on an automatically interleaved manner. Therefore, the user does not have to watch a content for a long time before the next content is displayed. In addition, the user need not operate the device in order to skip undesired contents. The user can easily get a general idea of each of various contents distributed from the network without performing special operations. For the contents distribution side, it is possible to increase the number of contents viewed by the user since plural contents are displayed part by part on an interleaved manner.

These embodiments provide means by which the user can select his interested content for displaying it continuously. It is also possible to notify the distribution side that a content is selected. This allows the contents creator to know how much interest is gathered by the content. In addition, it is possible to charge the user if a content is displayed continuously. Therefore, the distribution service may designed in such a manner that a content is displayed continuously or intermittently depending on whether the user pays a fee.

In these embodiments, since the order of contents to be displayed is determined by the display device side, no control is required on the contents distribution side for the display order. In addition, since the order of contents to be displayed is not determined by the central server, other devices can distribute contents, allowing less restrained distribution of contents.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A contents display device comprising:
a communication unit for implementing communication with a network;
a storage unit for storing plural contents received by the communication unit; and
a display unit used for displaying the plural contents, wherein parts of the respective contents are extracted part by part and the part extracted is displayed sequentially.

2. A contents display device according to claim 1 wherein if, while a part of a content is being displayed, the contents display device is instructed to continuously display the content, the display unit continuously displays the whole content including said part.

3. A contents display device according to claim 1 wherein said content includes plural still images and said part is one of the plural still images.

4. A contents display device according to claim 3 wherein when said display unit displays one still image of a predetermined content, subsequently displays another content, and then displays the predetermined content again, said display unit displays another still image subsequent to said one still image of the predetermined content.

5. A contents display device according to claim 1 wherein each of the plural contents includes a motion picture divided into divisions by a predetermined period of time, and when each of the plural contents is displayed again, the motion picture assigned to a division subsequent to one that was last displayed is displayed.

6. A contents display device according to claim 2 wherein upon receipt of the instruction of continuous display of the current content, the contents display device signals to a server which distributed the content that the content is selected.

7. A contents display device according to claim 6 wherein upon receipt of the instruction of continuous display of the current content, the contents display device indicates that the user is charged for this continuous display and, if this charging is accepted by the user, sends accounting information to an accounting management server before starting the continuous display of the content.

8. A contents display device according to claim 1 wherein the communication unit periodically obtains contents distributed via the network and updates the storage unit with the obtained contents.

9. A contents display device according to claim 1 wherein if it is detected that the contents display device is in an access range of the network, the contents display device obtains and displays contents distributed via the network.

10. A contents display device according to 1 wherein if it is detected that the contents display device is disconnected from the network or connected to another network, the contents display device stops displaying the contents distributed via the formerly connected network.

11. A contents display method by a terminal device provided with a communication unit for implementing communication with a network and a display unit used for displaying contents received by the communication unit, said method comprising the steps of:
storing plural contents received by the communication unit; and
extracting parts of the respective contents part by part and displaying the part extracted sequentially.

12. A contents display method according to claim 11 wherein if, while a part of a content is being displayed, the terminal device is instructed to continuously display the content, the terminal device continuously displays the whole content including said part.

13. A contents display method according to claim 11 wherein said content includes plural still images and said part is one of the plural still images.

14. A contents display method according to claim 13 wherein when said display unit displays one still image of a predetermined content, subsequently displays another content, and then displays the predetermined content again, said display unit displays another still image subsequent to said one still image of the predetermined content.

15. A contents display method according to claim 11 wherein each of the plural contents includes a motion picture divided into divisions by a predetermined period of time, and when each of the plural contents is displayed again, the motion picture assigned to a division subsequent to one that was last displayed is displayed.

16. A contents display method according to claim 12 wherein upon receipt of the instruction of continuous display of the current content, the terminal device signals to a server which has distributed the content that the content is selected.

17. A contents display method according to claim 16 wherein upon receipt of the instruction of continuous display of the current content, the terminal device indicates that the user is charged for this continuous display and, if this charging is accepted by the user, sends accounting information to an accounting management server before starting the continuous display of the content.

18. A contents display method according to claim 11 wherein the communication unit periodically obtains contents distributed via the network and updates the stored contents.

19. A contents display method according to claim 11 wherein if it is detected that the terminal device is in an access range of the network, the terminal device obtains and displays the contents distributed via the network.

20. A contents display method according to 11 wherein if it is detected that the terminal device is disconnected from the network or connected to another network, the terminal device stops displaying the contents distributed via the formerly connected network.

21. A contents distribution and display system comprising:
a communication network;
a distribution server, connected to the communication network, for distributing contents each consisting of plural images or a motion picture; and
a contents display device including:
a communication unit for implementing communication with the communication network;
a storage unit for store plural contents received by the communication unit; and
a display unit used for displaying the plural contents, wherein parts of the respective contents are extracted part by part and the part extracted is displayed sequentially.
